(19) United States
(12) Patent Application Publication
(10) Pub. No.: US 2015/0074595 A1
(43) Pub. Date: Mar. 12, 2015

(54) Electronic Book Apparatus, Page Feeding Method, and Page Feeding Program of Electronic Book

(71) Applicant: Alpine Electronics, Inc., Tokyo (JP)

(72) Inventors: Takashi Kashiwagi, Iwaki (JP); Yu Sagi, Iwaki (JP)

(21) Appl. No.: 14/465,576

(22) Filed: Aug. 21, 2014

(30) Foreign Application Priority Data
Sep. 9, 2013 (JP) 2013-185908

(51) Int. Cl. G06F 3/0484; G06F 3/0488; G06F 3/0485

(52) U.S. Cl. CPC G06F 3/04842; G06F 3/04855; G06F 3/0488
USPC 715/786

(57) ABSTRACT

The electronic book apparatus includes an already-read information giving unit 15 configured to give already-read information for a viewed page and a page feeding processing unit 14 configured to perform page feeding processing within a range of pages to which the already-read information is given when page feeding operation is performed. Further, even when the user returns from the half-read page back to an already-read page to view the already-read page and then performs an operation to feed pages to an unread page beyond the original page, the feeding of the pages is stopped at the last page of the already-read pages, thereby preventing an unread page from being inadvertently displayed. The user may also return back to the original page without performing cumbersome operations to give and delete bookmark information to the half-read page.

### RELATED APPLICATIONS

The present application claims priority to Japanese Patent Application Serial Number 2013-185908, filed Sep. 9, 2013, the entirety of which is hereby incorporated by reference.

### BACKGROUND OF THE INVENTION

1. Field of the Invention

The present invention relates to an electronic book apparatus, a page feeding method, and a page feeding program of an electronic book. More particularly, the present invention is suitable for use with an electronic book apparatus having a page feeding function for feeding multiple pages at a time and displaying a page.

2. Description of the Related Art

In recent years, electronic book apparatuses have become widely available that are able to display electronic books, where electronics books include the contents of books that have been digitized. The electronic book apparatuses include not only an example achieved as an application program operating on a portable electronic terminal such as a smartphone and a tablet, but also as an apparatus achieved through dedicated hardware.

In an electronic book, usually, an image is constituted for each page, and the pages are displayed in units of pages. For this reason, the electronic book apparatus has a page turning function so as to allow a user to turn pages as the user views an electronic book. More specifically, every time the user performs a flick operation for turning a page, an image is displayed upon switching to a next page.

There is an electronic book apparatus that has a page feeding function for displaying a page upon feeding multiple pages at once, instead displaying a page upon turning each page. For example, as shown in FIG. 5, an electronic book apparatus is known in which, a scroll bar 102 is displayed at a lower portion of a page image 101, and pages are fed in accordance with the amount of operation of sliding of a knob 102a. The left end of the scroll bar 102 corresponds to the first page of the electronic book, and the right end of the scroll bar 102 corresponds to the final page of the electronic book.

While the user is reading an electronic book, the user may want to return back to a page that the user has already read in order to read that page again, and thereafter, the user may desire to return back to the original page to continue reading at that page. In such a case, the user can make use of the page feeding function. More specifically, the user can move a knob 102a of a scroll bar 102 as show in FIG. 5 from the right to the left side by a predetermined amount to return back to an already-read page, and thereafter, the user then moves the knob 102a from the left to the right side to feed the page back to the original position, and thus the user can return back to the original page to continue reading.

However, when the user tries to return back to the original position by moving the knob 102a of the scroll bar 102 to the right side, the user may move the knob 102a of the scroll bar 102 too much, and an unread page may be displayed. If this occurs, the user may unintentionally read a subsequent portion of the plot of the story, which is not preferable. In particular, when the user is reading an electronic book such as a comic book, which the user can easily roughly descern the contents of by looking at a picture, it is desired to avoid even displaying an unread page.

To address this issue, JP 2006-331094 A, for example, suggests a technique, in which when page turning processing from a desired page to a next page is performed. Processing is performed to determine that the desired page is already-read, and the color of texts on the page that is determined to be already-read is changed, or a color is given to the background of the page that is determined to be already-read. For example, JP 2011-95932 A suggests a technique for determining a previously-displayed block that is displayed in a display area before scrolling and determining a subsequently-displayed block that is updated and displayed in the display area after scrolling, and changing the speed of scrolling for the previously-displayed block and the subsequently-displayed block.

### SUMMARY OF THE INVENTION

In the technique described in JP 2006-331094 A), the already-read page and the unread page can be distinguished from each other in accordance with the display color on the page, but when the user manipulates the scroll bar 102 and feeds the page one at a time, it is inevitable to move to and display the unread page. Even in the technique described in JP 2011-95932 A, the speed of scrolling can only be changed for the previously-displayed block (already-read block) and the subsequently-displayed block (unread block), and this cannot solve the problem in that an unread page is displayed when the user performs page feeding operation more than necessary.

Most of the electronic book apparatuses have a bookmark function capable of giving bookmark information related to a page being read, so that the bookmark can be used as a mark. When this bookmark function is used instead of the page feeding function, the user can return back to the already-read page to read the page again, and thereafter the user can return back to the original page again (the page to which the bookmark information is given) to continue to read the page. Therefore, this can avoid the problem that the unread page is displayed by mistake.

However, in this case, before the user operates the scroll bar 102 to return back to the already-read page, it is necessary for the user to perform an operation to set bookmark information to the half-read page that the user is reading now. In addition, after the user checks the already-read page and returns back to the original page, it is necessary for the user to perform an operation to delete the bookmark information set to that page. Therefore, there is a problem in that it is cumbersome to perform the operation.

The present invention is made to solve such problems, and it is an object of the present invention to allow a user to easily perform an operation to return back to an original page without an unread page being unintentionally displayed when the user moves from the half-read page back to an already-read page, and then after viewing the already-read page, the user then returns back to the original half-read page.

In order to address the above problem, in the present invention, already-read information indicating an “already-viewed state” is given to a page of an electronic book that the user has already viewed. When the user performs a page feeding operation, page feeding processing is performed to feed multiple pages from the currently-displayed page within the range of the pages to which the already-read information is given.

When the user moves from the half-read page back to an already-read page to view the already-read page, and thereafter the user performs the page feeding processing to return back to the original half-read page, the pages are fed while limiting to pages to which the already-read information is given. Therefore, even when the user performs an operation to feed pages to an unread page beyond the range of the already-read pages, the pages are not fed to the unread page, thereby preventing the unintention display of an unread page.

In addition, in the user's operation for returning back to the original page, it is not necessary to perform a complicated operation for setting and deleting bookmark information for a half-read page, as the user only performs the page feeding operation. Moreover, in the page feeding operation, it is not necessary for the user to adjust the amount of pages fed during the operation so as to return back to exactly the original page. When the user intentionally performs the page feeding operation that would advance to an unread page beyond the range of the already-read pages, the page feeding processing for feeding pages automatically advances to exactly the original page. Therefore, the user can return back to the original page with an easy operation.

### BRIEF DESCRIPTION OF THE DRAWINGS

FIG. 1 is a block diagram illustrating an example configuration of functions of an electronic book apparatus;

FIG. 2 is a figure illustrating an example operation of a page feeding processing unit;

FIG. 3 is a flowchart illustrating an example operation of an electronic book apparatus;

FIG. 4 is a figure illustrating another example of a page feeding operation; and

FIG. 5 is a figure illustrating a generally-available page feeding function in a related-art electronic book apparatus.

### DESCRIPTION OF THE PREFERRED EMBODIMENTS

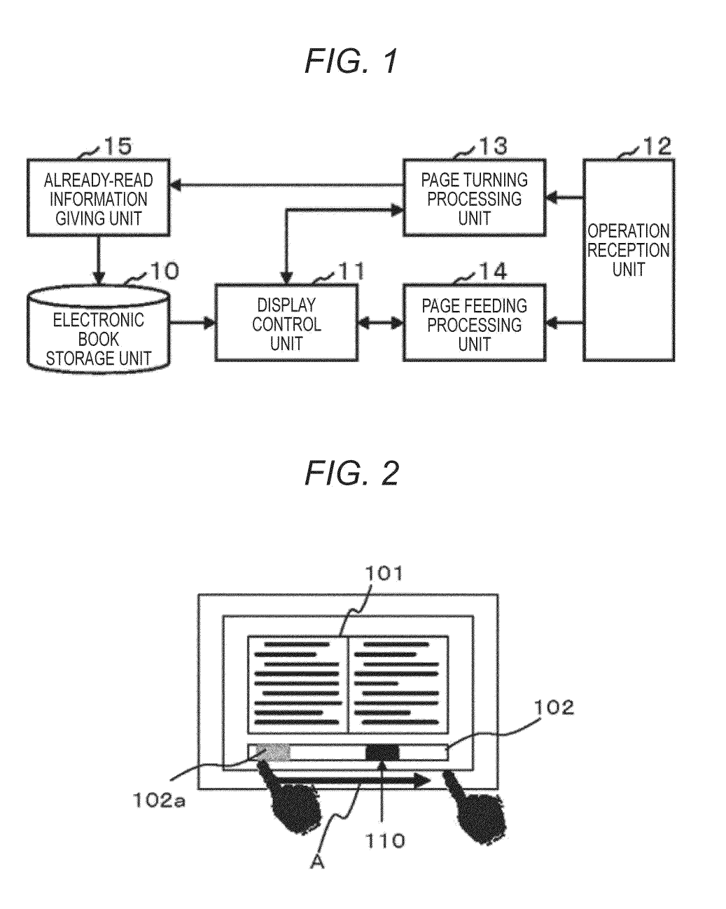

FIG. 1 is a block diagram illustrating an example configuration of functions of the electronic book apparatus. As shown in FIG. 1, the electronic book apparatus may include an electronic book storage unit 10, a display control unit 11, an operation reception unit 12, a page turning processing unit 13, a page feeding processing unit 14, and an already-read information giving unit 15.

Each of the above function blocks 11 to 15 may be constituted by any one of hardware, a Digital Signal Processor (DSP), and software. For example, when each of the above function blocks 11 to 15 is constituted by software, each of the function blocks 11 to 15 are actually configured to include a CPU, a RAM, a ROM, and the like of a computer, and is achieved when a program recorded in a recording medium such as a RAM, a ROM, a hard disk, a semiconductor memory, or the like (including the page feeding program of the present invention) operates.

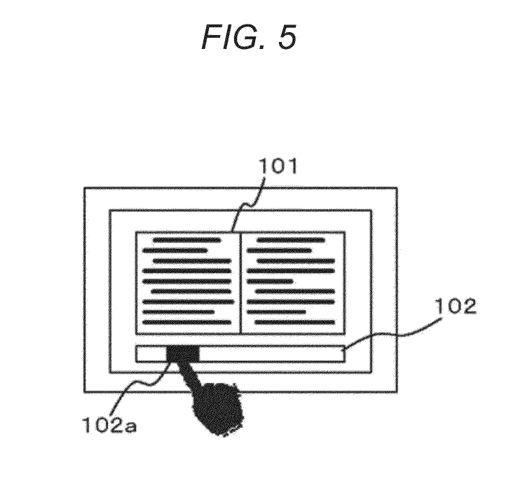

The electronic book storage unit 10 stores data of an electronic book. In the electronic book, an image is configured for each page. As shown in FIG. 5, the display control unit 11 displays a page image 101 constituting each page of an electronic book, and displays a scroll bar 102 in an area different from the page image 101. A page image displayed on a screen may be one page or may be two pages. In the example of FIG. 5, two pages of page images are displayed in a double-page spread state.

The operation reception unit 12 receives an operation of a user with the electronic book apparatus. For example, a touch panel is provided on the display screen of the electronic book apparatus, and the operation reception unit 12 receives a user's operation with the touch panel. More specifically, the operation reception unit 12 receives a page turning operation for displaying a page by turning pages one by one and a page feeding operation for feeding multiple pages at a time to display a page.

In this case, the page turning operation is a flick operation that is performed from the left to the right side or from the right to the left side in the portion where the page image 101 is displayed. For example, in a case where two pages of the page image 101 is displayed as a double-page spread as shown in FIG. 5 where the page number is smaller in the left side page, a flick operation from the right to the left side starting from the area where the right side page image is displayed is a page turning operation for feeding a page by one (advancing a page forward). Alternatively, a flick operation from the left to the right side starting from the area where the left side page image is displayed is a page turning operation for returning a page backward by one.

On the other hand, the page feeding operation is a tracing operation for moving the knob 102a of the scroll bar 102 from the left to the right side or from the right to the left side. The left end of the scroll bar 102 corresponds to the first page of the electronic book, and the right end of the scroll bar 102 corresponds to the last page of the electronic book. The knob 102a of the scroll bar 102 is displayed at a position corresponding to the page number of the currently-displayed page image 101, and tracing operation for sliding the knob 102a of the scroll bar 102 from the right to the left side is the page feeding operation for returning multiple pages at a time. On the contrary, tracing operation for sliding the knob 102a of the scroll bar 102 from the left to the right side is a page feeding operation for moving multiple pages forward at a time.

The page turning processing unit 13 performs page turning to turn pages from the currently-displayed page to a next page or a previous page in accordance with the page turning operation performed by the user and received with the operation reception unit 12. The page feeding processing unit 14 performs page feeding to feed pages from the currently-displayed page to multiple pages ahead or multiple pages back at a time in accordance with the page turning operation performed by the user and received with the operation reception unit 12. At this occasion, the display control unit 11 displays the page image 101 to which the page is transited as a result of the page turning or the page feeding.

The already-read information giving unit 15 gives already-read information indicating an “already-viewed state” to the page, which is viewed by the user, of the multiple pages constituting the electronic book stored in the electronic book storage unit 10. For example, when the page turning processing unit 13 performs the page turning processing to move from the currently-displayed page to the next page, the already-read information giving unit 15 provides already-read information for the next page. More specifically, the already-read information is provided and stored to the page in question of the electronic book stored in the electronic book storage unit 10. In a case where two pages of page image 101 are displayed in a double-page spread state as shown in FIG. 5, the next page means the next two pages in the double-page spread state that is newly displayed when a page is turned.

When the operation reception unit 12 receives a page feeding operation, the page feeding processing unit 14 explained above performs page feeding processing for feeding multiple pages from the currently-displayed page within a range of pages to which the already-read information is given by the already-read information giving unit 15. For example, in a case where tracing operation is performed to slide the knob 102a of the scroll bar 102 from the current position to the left side, this is to feed pages from the currently-displayed already-read page to an already-read page which is several pages before the currently-displayed already-read page, and therefore, the page feeding processing unit 14 executes this page feeding processing as usual.

Alternatively, in a case where a tracing operation is performed to slide the knob 102a of the scroll bar 102 from the current position to the right side, this is, in accordance with the amount of operation, to feed pages from the currently-displayed already-read page to an already-read page which is several pages after the currently-displayed already-read page or to feed pages from the currently-displayed already-read page to an unread page which is several pages after the currently-displayed already-read page. In the former page feeding operation, the pages are fed within the range of the pages to which the already-read information is given, and therefore, the page feeding processing unit 14 executes this page feeding processing as usual.

However, in the latter page feeding operation, the pages are fed beyond the range of the pages to which the already-read information is given, and therefore, the page feeding processing unit 14 executes the page feeding processing as follows. In a case where the page feeding operation is performed to feed pages from the currently-displayed already-read page to an unread page to which the already-read information is not given by the already-read information giving unit 15, the page feeding processing unit 14 stops the page feeding processing at the last page of the already-read pages to which the already-read information is given.

FIG. 2 is a figure illustrating an example operation of the page feeding processing unit 14. The position indicated by arrow 110 in FIG. 2 is considered to be the last page of the already-read pages to which the already-read information is given. Then, suppose that, as indicated by arrow A, the user performs page feeding operation from the currently-displayed already-read page to an unread page several pages after the currently-displayed already-read page which is beyond the range of the already-read pages to which the already-read information is given. In this case, the page feeding processing unit 14 stops the page feeding processing at the last page of the already-read pages to which the already-read information is given. At this occasion, the display control unit 11 displays the page image 101 of the last page of the already-read pages, and stops the knob 102a of the scroll bar 102 at the position of the arrow 110.

Accordingly, for example, the user reads the electronic book to the page at the position indicated by arrow 110, the user moves the knob 102a of the scroll bar 102 to the left side by a desired amount so as to display an already-read page and the user checks the contents thereof. Thereafter, the user moves the knob 102a to the right side of the position of arrow 110, so that the feeding of the pages is stopped at the half-read original page. Therefore, the user can easily return back to the original page to continue reading the pages.

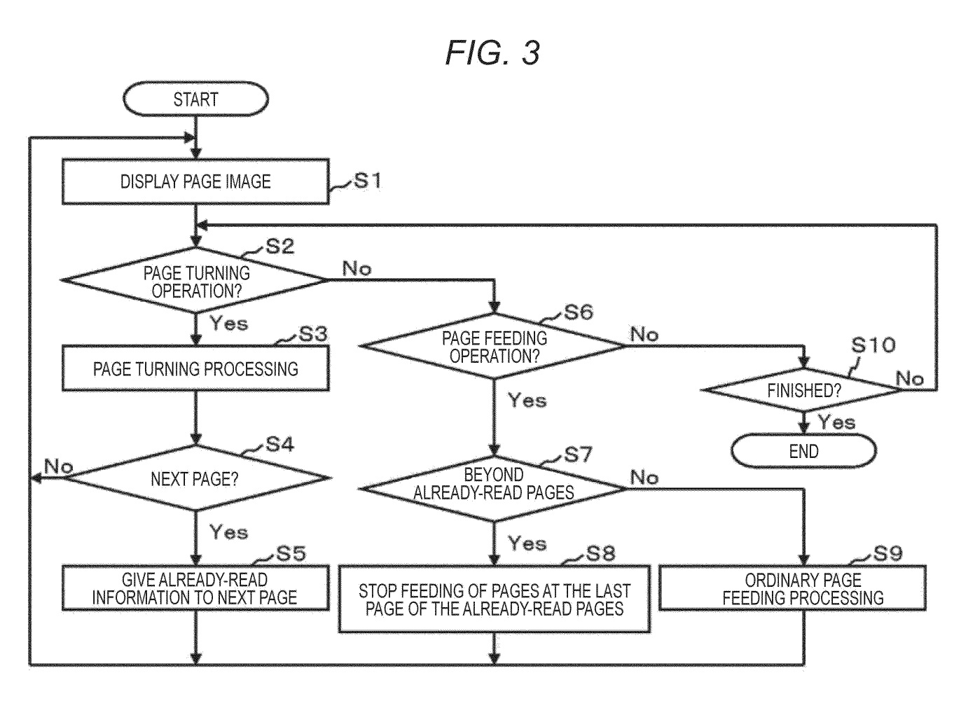

FIG. 3 is a flowchart illustrating an example of operation of the electronic book apparatus according to the present embodiment configured as described above. The flowchart as shown in FIG. 3 is started when the user performs operation with the touch panel to give a command for displaying a desired electronic book from among the electronic books in the electronic book storage unit 10.

First, the display control unit 11 displays a page image 101 (the first page in initial state) of an electronic book and the scroll bar 102 (step S1). Subsequently, the operation reception unit 12 determines whether or not the operation reception unit 12 receives a page turning operation for displaying pages while turning pages one by one (step S2). When the operation reception unit 12 receives a page turning operation, the page turning processing unit 13 performs page turning processing for turning a page from the currently-displayed page to a next page or a previous page in accordance with the direction of the page turning operation (step S3).

In a case where the page turning processing unit 13 performs the page turning processing, the already-read information giving unit 15 determines whether it is a page turning processing for moving from the currently-displayed page to a next page (step S4). When it is determined to be a page turning processing for moving to a next page, the already-read information giving unit 15 gives already-read information for the next page (step S5). Thereafter, the processing in step S1 is subsequently performed. In this case, the display control unit 11 displays the page image 101 of the next page turned to in step S3.

On the other hand, when the processing performed by the page turning processing unit 13 is determined not to be the page turning processing for moving to the next page in step S4, i.e., when the processing performed by the page turning processing unit 13 is determined to be a page turning processing for returning back to a previous page, the processing in step S5 is not performed, and step S1 is subsequently performed. In this case, the display control unit 11 displays the page image 101 of the previous page turned to in step S3.

When the operation reception unit 12 determines that the operation reception unit 12 does not receive the page turning operation in step S2 explained above, the operation reception unit 12 then determines whether the operation reception unit 12 receives a page feeding operation for feeding multiple pages at a time (step S6). When the operation reception unit 12 receives the page feeding operation, the page feeding processing unit 14 determines whether it is a page feeding for feeding pages beyond the range of the already-read pages to which the already-read information is given (step S7).

When it is determined to be the feeding of pages beyond the range of the already-read pages, the page feeding processing unit 14 stops the page feeding processing at the last page of the already-read pages to which the already-read information is given (step S8). Thereafter, the processing is step S1 is performed back again. In this case, the display control unit 11 displays the page image 101 of the last page of the already-read pages.

On the other hand, when it is not the feeding of pages beyond the range of the already-read pages, the page feeding processing unit 14 executes ordinary page feeding processing (step S9). Thereafter, the processing in step S1 is subsequently performed.

In this case, the display control unit 11 displays the page image 101 of the page fed.

When the operation reception unit 12 determines that the operation reception unit 12 does not receive the page feeding operation in step S6 explained above, the operation reception unit 12 then determines whether the operation reception unit 12 receives an operation for terminating viewing of the electronic book (for example, an operation for closing the electronic book or an operation for turning off the electronic book apparatus) (step S10). When the operation reception unit 12 does not receive this operation, the processing in step S2 is performed back again. On the other hand, when the operation reception unit 12 receives this operation, the processing in the flowchart as shown in FIG. 3 is terminated.

As discussed above, in the present embodiment, the already-read information indicating the already-viewed state is given to the pages, which are viewed by the user, of among multiple pages constituting the electronic book (more specifically, the pages displayed by the page turning processing), and when the user performs the page feeding operation, the page feeding processing is performed to feed multiple pages from the currently-displayed page within the range of the pages to which the already-read information is given.

In implementations that are configured as described above, suppose that the user moves from the half-read page back to an already-read page to view the already-read page. The user performs page feeding processing to return back to the original half-read page, and the user performs an operation to feed pages to an unread page beyond the range of the already-read pages. Even in such a case, the pages are not fed to the unread page, and this prevents the unread page from being displayed unintendedly.

Moreover, as user's operation required for returning back to the original page, it is not necessary for the user to perform the cumbersome operation of giving bookmark information to the half-read page and deleting the bookmark information, as the user only has to do the page feeding operation. In addition, in the page feeding operation, the user is not at all required to adjust the amount of operation so as to exactly return back to the original page. Further, when the user intentionally performs the page feeding operation with such an amount of pages that the operation advances to an unread page beyond the range of the already-read pages, the pages are automatically fed exactly to the original page. Therefore, with an easy operation, the user can return back to the original page and continue to read the pages.

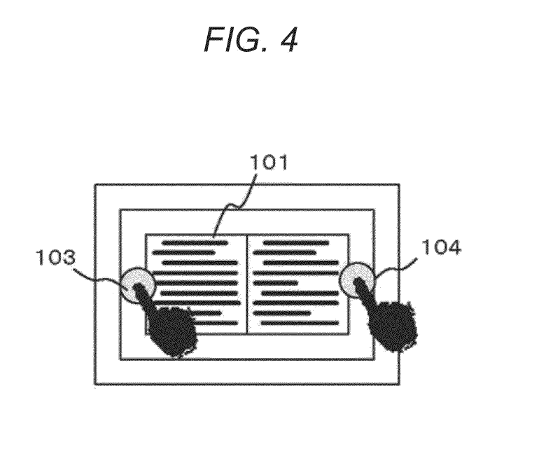

In the discussion above, for example, the scroll bar 102 is used to perform the page feeding operation, but the present invention is not limited thereto. For example, as shown in FIG. 4, an operation for continuously pressing down an edge portion of the page image 101 displayed by the display control unit 11 for a predetermined time or more may be adopted as a page feeding operation. In the example of FIG. 4, when the user long-presses the edge portion 103 at the left side of the page image 101 for a predetermined time or more, the page feeding processing unit 14 executes the page feeding processing for returning multiple pages at a time while the user presses the edge portion 103 at the left side even after the predetermined time elapses.

On the contrary, when the user long-presses the edge portion 104 at the right side of the page image 101 for a predetermined time or more, the page feeding processing unit 14 executes the page feeding processing for moving multiple pages forward at a time while the user presses the edge portion 104 at the right side even after the predetermined time elapses. Even when the page feeding processing is performed with such long-press operation, the page feeding processing unit 14 performs the page feeding processing within the range of the pages to which the already-read information is given by the already-read information giving unit 15. More specifically, when the user continues to press the edge portion 104 at the right side for such a long time that the pages are fed from the currently-displayed already-read page to the unread page, the page feeding processing unit 14 stops the feeding of the pages at the last page of the already-read pages to which the already-read information is given.

In the explanation about the above embodiment, for example, the already-read information giving unit 15 gives the already-read information to a next page when the page turning processing unit 13 performs page turning processing for turning the page to the next page. More specifically, when a page image 101 of a new page is displayed as a result of the page turning processing, the new page is deemed as being viewed by the user, and the already-read information is given to the new page, but the present invention is not limited thereto.

For example, when page turning processing for moving from the currently-displayed page to a next page is performed, the already-read information may be given to the currently-displayed page. In this example, not only when the page image 101 is simply displayed but also when the page turning processing to the next page is performed, the page that is displayed is deemed as finishing reading, and the already-read information is given to the page that is read. However, when considering the convenience of the case where the user uses the page feeding processing to return back to the half-read page to continue reading the pages, it is preferable to add the already-read information to the next page when the page turning processing to the next page is performed as described in the above embodiment.

Any of the above embodiments is merely a description showing an example that is made to carry out the present invention, and it is to be understood that the technical scope of the present invention is not be interpreted in a limited manner by the above embodiment. More specifically, the present invention can be carried out in various forms without deviating from the gist or the main feature thereof.

It is therefore intended that the foregoing detailed description be regarded as illustrative rather than limiting, and that it be understood that it is the following claims, including all equivalents, that are intended to define the spirit and scope of this invention.

What is claimed is:

1. An electronic book apparatus comprising:
an already-read information giving unit configured to provide already-read information indicating an already-viewed state of a page of an electronic book that is rendered to a user; and
a page feeding processing unit configured to, in accordance with a page feeding operation performed by the user, perform page feeding processing to feed multiple pages from a currently-displayed page that are within a range of pages to which the already-read information giving unit provides already-read information indicating that the page of the electronic book has been rendered to the user.

2. The electronic book apparatus according to claim 1, wherein in a case where the user performs a page feeding operation for feeding pages from the currently-displayed already-read page to an unread page to which the already-read giving unit does not provide already-read information indicating that the page of the electronic book has been rendered to the user, the page feeding processing unit stops the page feeding processing at a last page of already-read pages to which the already-read information is given.

3. The electronic book apparatus according to claim 1, further comprising:
a display control unit configured to display a page image constituting each page of the electronic book, and configured to display a scroll bar in an area that is different from the page image; and
an operation reception unit configured to receive the page feeding operation that is performed in response to sliding the scroll bar displayed by the display control unit,
wherein the page feeding processing unit performs the page feeding processing in accordance with the page feeding operation received by the operation reception unit.

4. The electronic book apparatus according to claim 1, further comprising:
a display control unit configured to display a page image constituting each page of the electronic book; and
an operation reception unit configured to receive the page feeding operation that is performed by continuously pressing down an edge portion of the page image displayed by the display control unit for a predetermined time or more,
wherein the page feeding processing unit performs the page feeding processing in accordance with the page feeding operation received by the operation reception unit.

5. The electronic book apparatus according to claim 1, further comprising:
a page turning processing unit configured to perform page turning from the currently-displayed page to a next page in accordance with a page turning operation performed by the user,
wherein the already-read information giving unit provides the already-read information regarding the next page when the page turning processing unit performs the page turning processing.

6. A page feeding method for an electronic book comprising:
a first step in which when performing page turning processing to turn a page of the electronic book from a currently-displayed page to a next page in accordance with a page turning operation performed by a user, an already-read information giving unit of an electronic book apparatus provides already-read information indicating an already-viewed state of the next page; and
a second step in which performing, with a page feeding processing unit of the electronic book apparatus, in accordance with a page feeding operation performed by the user, page feeding processing for feeding multiple pages from the currently-displayed page that are within a range of pages to which the already-read information giving unit provides already-read information.

7. A non-transitory computer-readable storage medium comprising a page feeding program for an electronic book for causing a processor of a computer to function as:
an already-read information giving unit configured to provide already-read information indicating an already-viewed state of a page of an electronic book that is rendered to a user; and
a page feeding processing unit configured to, in accordance with a page feeding operation performed by the user, perform page feeding processing to feed multiple pages from a currently-displayed page that are within a range of pages to which the already-read information giving unit provides already-read information indicating that the page of the electronic book has been rendered to the user.
